(19) United States
(12) Patent Application Publication
(10) Pub. No.: US 2024/0049800 A1
(43) Pub. Date: Feb. 15, 2024

(54) POWER SUPPLY ASSEMBLY AND ELECTRONIC VAPORIZATION DEVICE

(71) Applicant: SHENZHEN SMOORE TECHNOLOGY LIMITED, Shenzhen (CN)

(72) Inventors: Zhenkun PENG, Shenzhen (CN); Songkai CHEN, Shenzhen (CN)

(21) Appl. No.: 18/360,784

(22) Filed: Jul. 27, 2023

(30) Foreign Application Priority Data
Aug. 9, 2022 (CN) 202210952138.6

(51) Int. Cl. A24F 40/485; A24F 40/10; A24F 40/51

(52) U.S. Cl. CPC A24F 40/485; A24F 40/10; A24F 40/51

(57) ABSTRACT

A power supply assembly includes: an electric core cavity and an electric control cavity that are independent of each other, the electric core cavity and electric control cavity being internally provided; and an airflow channel that is independent of the electric control cavity, the airflow channel being internally provided and extending from one end of the power supply assembly through the electric core cavity to an other end of the power supply assembly.

### CROSS-REFERENCE TO PRIOR APPLICATION

Priority is claimed to Chinese Patent Application No. 202210952138.6, filed on Aug. 9, 2022, the entire disclosure of which is hereby incorporated by reference herein.

### FIELD

This application relates to the field of vaporization technologies, and in particular, to a power supply assembly and an electronic vaporization device.

### BACKGROUND

An aerosol is a colloidal dispersion system formed by solid or liquid small particles dispersed and suspended in a gas medium. Because the aerosol may be absorbed by a human body through the respiratory system, a new alternative absorption method is provided for users. A vaporizer refers to a device that forms an aerosol by using a stored and vaporizable aerosol-forming substrate by heating or ultrasound. The vaporizable aerosol-forming substrate includes tobacco oil containing nicotine (nicotine), medical drugs, and the like. Vaporizing the aerosol-forming substrate can deliver the inhalable aerosol to the users, which replaces conventional product forms and absorption methods.

Current electronic vaporization devices generally include a shell and electric control components such as an electric core, a microphone, and a charging plate that are accommodated in the shell for power supply. When airflow flows through the shell, the condensate generated when cooled is adhered to these electric control components, which increases the risk of circuit shorts and causes damage to the electronic vaporization device.

### SUMMARY

In an embodiment, the present invention provides a power supply assembly, comprising: an electric core cavity and an electric control cavity that are independent of each other, the electric core cavity and electric control cavity being internally provided; and an airflow channel that is independent of the electric control cavity, the airflow channel being internally provided and extending from one end of the power supply assembly through the electric core cavity to an other end of the power supply assembly.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 is a schematic diagram of an electronic vaporization device according to an embodiment of this application;

FIG. 2 is a longitudinal cross-sectional view of the electronic vaporization device in FIG. 1;

FIG. 3 is a schematic structural diagram of an installation bracket according to an embodiment of this application;

FIG. 4 is a schematic structural diagram of the installation bracket in FIG. 3 from another perspective;

FIG. 5 is a schematic structural diagram of the installation bracket in FIG. 3 from another perspective; and

FIG. 6 is a schematic diagram of a partial inner structure of the electronic vaporization device in FIG. 1 being installed with a first seal plug.

### DETAILED DESCRIPTION

In an embodiment, the present invention provides a power supply assembly and an electronic vaporization device to resolve the problem of short circuit of electric control components caused by condensate adhered to the electric control components. The power supply assembly and the electronic vaporization device can effectively prevent condensate adhered to the electric control components from causing short circuit of the electric control components.

According to an aspect of this application, a power supply assembly is provided. The power supply assembly is internally provided with an electric core cavity and an electric control cavity that are independent of each other; and

the power supply assembly is further internally provided with an airflow channel that is independent of the electric control cavity, and the airflow channel extends from one end of the power supply assembly through the electric core cavity to the other end of the power supply assembly. In an embodiment, the power supply assembly further includes:

a shell that is provided with an accommodating cavity; and

an installation bracket that is accommodated in the accommodating cavity, the installation bracket separating the accommodating cavity to form the electric core cavity and the electric control cavity.

In an embodiment, the electric control cavity is formed at an end portion of one end of the installation bracket that is close to an air inlet end of the airflow channel.

In an embodiment, an end portion of one end of the installation bracket is provided with an air inlet hole used for forming the airflow channel, one end of the air inlet hole is in communication with the external environment, and the other end of the air inlet hole is in communication with the electric core cavity.

In an embodiment, the side wall of one end of the installation bracket that is close to the air inlet hole is provided with a first air outlet hole used for forming the airflow channel, and the electric core cavity and the outer side wall of the installation bracket are in communication through the first air outlet hole.

In an embodiment, the power supply assembly further includes an electric core, the electric core is accommodated in the electric core cavity, and a gap communicating the air inlet hole with the first air outlet hole exists between the end surface of one end of the electric core close to the air inlet hole and the cavity wall of the electric core cavity.

In an embodiment, the outer side wall of the installation bracket is provided with a communication groove used for forming the airflow channel, one end of the communication groove is in communication with the first air outlet hole, and the other end of the communication groove extends to an end portion of one end of the installation bracket that is away from the air inlet hole.

In an embodiment, the outer side wall of the installation bracket is provided with a liquid storage groove, and the liquid storage groove is in communication with the communication groove.

In an embodiment, the end portion of the end of the installation bracket that is away from the air inlet hole is provided with an airflow guide channel used for forming the airflow channel, and the airflow guide channel is located downstream of the communication groove and is configured to guide a gas in the communication groove toward an axis of the installation bracket.

In an embodiment, the end portion of the end of the installation bracket that is away from the air inlet hole is provided with a second air outlet hole used for forming the airflow channel, and the second air outlet hole is located downstream of the airflow guide channel and is provided for the gas in the airflow guide channel to flow out of the installation bracket.

In an embodiment, the power supply assembly further includes a liquid absorbing member, and the liquid absorbing member is embedded in the end portion of the end of the installation bracket that is away from the air inlet hole and faces the airflow guide channel along an axial direction of the installation bracket.

In an embodiment, the power supply assembly is provided with an air inlet hole that forms the airflow channel, one end of the air inlet hole is in communication with the external environment, the other end of the air inlet hole is in communication with the electric core cavity, and the air inlet hole is provided with a seal surface configured to be engaged in a sealing manner with a seal plug that seals the air inlet hole; and

the power supply assembly further includes a microphone, the microphone is accommodated in the electric control cavity, the inner surface of the air inlet hole is provided with a start channel that is in communication with the electric control cavity for accommodating the microphone, and the start channel is located upstream of the seal surface.

According to an aspect of this application, an electronic vaporization device is provided, including the foregoing power supply assembly, and the electronic vaporization device further including a vaporization assembly, where the vaporization assembly is engaged with one end of the power supply assembly and is in communication with the airflow channel.

For the foregoing electronic vaporization device, because of the independent arrangement of the airflow channel and the electric control cavity, the air that flows through the airflow channel does not pass through the electric control cavity, which effectively prevents the condensate generated when cooled from being adhered to the electric control components in the electric control cavity, and reduces the risk of short circuits.

### REFERENCE NUMERALS

1000. Electronic vaporization device;
100. Vaporization assembly; 120. Vaporization housing; 140. Vaporization core; 160. Air exhaust channel; 180. Liquid storage cavity;
200. Power supply assembly; 210. Shell; 212. Air outlet channel; 214. Electric core cavity; 215. Electric control cavity;
230. Electric core; 240. Microphone; 250. Charging plate; 260. Installation bracket; 261. First axial portion; 2612. Air inlet hole; 2614. Start channel; 263. Second axial portion; 2632. Airflow guide groove; 2634. Airflow guide plate; 2636. Airflow guide channel; 2638. Second air outlet hole; 265. Intermediate connection portion; 2652. First air outlet hole;
2654. Communication groove; 2656. Liquid storage groove; 270. Liquid absorbing member;
300. First seal plug; 320. Seal portion; and 400. Second seal plug.

To make the foregoing objects, features and advantages of this application more comprehensible, detailed description is made to specific implementations of this application below with reference to the accompanying drawings. In the following description, many specific details are described to give a full understanding of this application. However, this application may be implemented in many other manners different from those described herein. A person skilled in the art may make similar improvements without departing from the connotation of this application. Therefore, this application is not limited to the specific embodiments disclosed below.

In the description of this application, it should be understood that orientation or position relationships indicated by the terms such as “center”, “longitudinal”, “transverse”, “length”, “width”, “thickness”, “on”, “below”, “front”, “back”, “left”, “right”, “vertical”, “horizontal”, “top”, “bottom”, “inside”, “outside”, “clockwise”, “anticlockwise”, “axial direction”, “radial direction”, and “circumferential direction” are based on orientation or position relationships shown in the accompanying drawings, and are used only for ease and brevity of illustration and description, rather than indicating or implying that the mentioned apparatus or component must have a particular orientation or must be constructed and operated in a particular orientation. Therefore, such terms should not be construed as limiting of this application.

In addition, the terms “first” and “second” are only used for the purpose of description, and cannot be understood as indicating or implying relative importance or implicitly indicating the quantity of indicated technical features. Therefore, a feature restricted by “first” or “second” may explicitly indicate or implicitly include at least one of such features. In the description of this application, “a plurality of” means at least two, such as two and three unless it is specifically defined otherwise.

In this application, unless otherwise explicitly specified and defined, terms such as “mounted”, “connected”, “connection”, and “fixed” should be understood in a broad sense. For example, the connection may be a fixed connection, a detachable connection, or an integral connection; or the connection may be a mechanical connection or an electrical connection; or the connection may be a direct connection, an indirect connection through an intermediate medium, or internal communication between two elements or a mutual action relationship between two elements, unless otherwise explicitly specified. A person of ordinary skill in the art may understand the specific meanings of the foregoing terms in this application according to specific situations.

In this application, unless otherwise explicitly specified and defined, a first feature is “on” or “below” a second feature may mean that the first feature and the second feature are in direct, or the first feature and the second feature are in indirect contact through an intermediate medium. Moreover, the first feature “over”, “above” and “up” the second feature may be that the first feature is directly above or obliquely above the second feature, or simply indicates that a horizontal height of the first feature is higher than that of the second feature. The first feature “under”, “below” and “down” the second feature may be that the first feature is directly below or obliquely below the second feature, or simply indicates that a horizontal height of the first feature is less than that of the second feature.

It should be noted that, when an element is referred to as “being fixed to” or “being arranged on” another element, the element may be directly on the another element, or an intermediate element may also be present. When an element is considered to be “connected to” another element, the element may be directly connected to the another element, or an intermediate element may also be present. The terms “vertical”, “horizontal”, “upper”, “lower”, “left”, “right”, and similar expressions used in this specification are merely used for an illustrative purpose, and do not represent the only implementation.

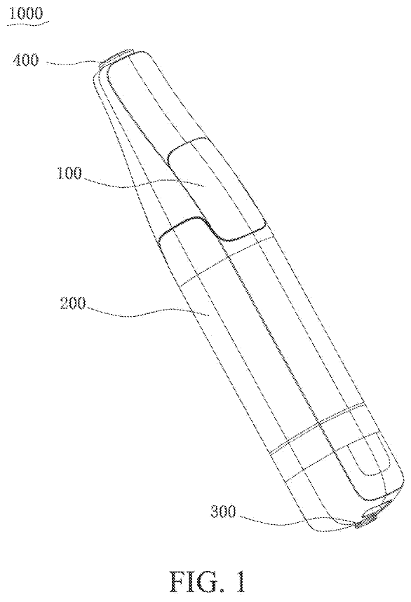

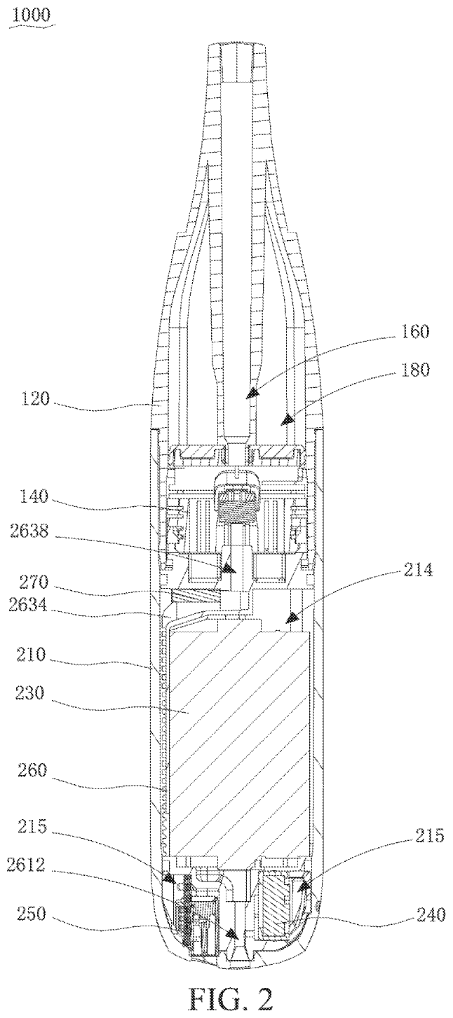

As shown in FIG. 1 and FIG. 2, an embodiment of this application provides an electronic vaporization device 1000, configured to vaporize an aerosol-forming substrate to generate an aerosol for people to inhale. The electronic vaporization device 1000 includes a vaporization assembly 100 and a power supply assembly 200, the vaporization assembly 100 is connected to one end of the power supply assembly 200 and is electrically connected to the power supply assembly 200, and the vaporization assembly 100 can heat and vaporize the aerosol-forming substrate by using the electrical energy of the power supply assembly 200.

Specifically, the vaporization assembly 100 includes a vaporization housing 120 and a vaporization core 140. The vaporization housing 120 is shell-shaped with an opening at an end. The vaporization core 140 is accommodated in an open end of the vaporization housing 120, and the other end of the vaporization housing 120 is provided with an air exhaust channel 160 and a liquid storage cavity 180 surrounding the air exhaust channel 160 in a circumferential direction. One end of the air exhaust channel 160 is in communication with the vaporization core 140, and the other end of the air exhaust channel 160 is in communication with the external environment through a closed end of the vaporization housing 120. The liquid storage cavity 180 is configured to store the aerosol-forming substrate. The aerosol-forming substrate in the liquid storage cavity 11 can flow into the vaporization core 140 and be heated and vaporized by the vaporization core 140. The aerosol generated by vaporization can flow out of the vaporization housing 120 through the air exhaust channel 160 for a user to inhale.

The power supply assembly 200 is connected to one end of the vaporization assembly 100 that is provided with the vaporization core 140. The power supply assembly 200 is internally provided with an electric core 230, a microphone 240, and a charging plate 250. The electric core 230 is electrically connected to the vaporization core 140 to supply power to the vaporization core 140. The charging plate 250 is configured to connect an external power source to charge the electric core 230, and the microphone 240 is configured to sense the airflow in the power supply assembly 200 to control a working state of the electronic vaporization device 100.

As described in the Background section above, the electric control components such as the electric core, the microphone, and the charging plate in the existing power supply assembly are all accommodated in a same cavity. The charging plate, the electric core, and the microphone are arranged sequentially along an axial direction of the power supply assembly and are not separated from each other. During suction, there is an airflow flowing through these electric control components, and the condensate generated by the return airflow when cooled is adhered to the surface of the electric control components, thereby increasing the risk of short circuits.

In order to solve the foregoing technical problems, the power supply assembly 200 of this application is provided an electric core cavity 214 and an electric control cavity 215 that are independent of each other, as well as an airflow channel that is independent of the electric control cavity 215. The airflow channel extends from one end of the power supply assembly 200 along the axial direction of the power supply assembly 200 through the electric core cavity 214 to the other end of the power supply assembly 200. The electric core cavity 214 is configured to accommodate the electric core 230, and the electric control cavity 215 is configured to accommodate electric control components such as the microphone 240 or the charging plate 250. “Independent” means that there is a clear separation between cavities, which blocks the air and prevents the air from flowing smoothly between the cavities, but does not mean that the cavities are completely sealed and there is no airflow at all.

Because of the independent arrangement of the airflow channel and the electric control cavity 215, the air that flows through the airflow channel does not pass through the electric control cavity 215, which effectively prevents the condensate generated when cooled from being adhered to the electric control components in the electric control cavity 215, and reduces the risk of short circuits.

Referring to FIG. 1 and FIG. 2, the power supply assembly 200 includes a shell 210 and an installation bracket 260. The shell 210 is provided with an accommodating cavity, and the installation bracket 260 is accommodated in the shell 210, configured to separate the accommodating cavity to form the electric core cavity 214 and the electric control cavity 215, and plays a supporting and limiting role in the vaporization core 140 of the vaporization assembly 100.

Specifically, the shell 210 is generally in a hollow columnar structure, including the bottom wall of the shell and the side wall of the shell that extends in the same direction from the edge of the bottom wall of the shell. The side wall of the shell surrounds the bottom wall of the shell in a circumferential direction to form the accommodating cavity with an opening at one end.

It can be understood that the shape and construction of the shell 210 are not limited and can be set as needed to meet different requirements.

In the following embodiment, a central axial direction of the shell 210 extends along a direction Z in FIG. 1, a radial direction of the shell 210 is perpendicular to the direction Z, and a circumferential direction of the shell 210 surrounds the direction Z.

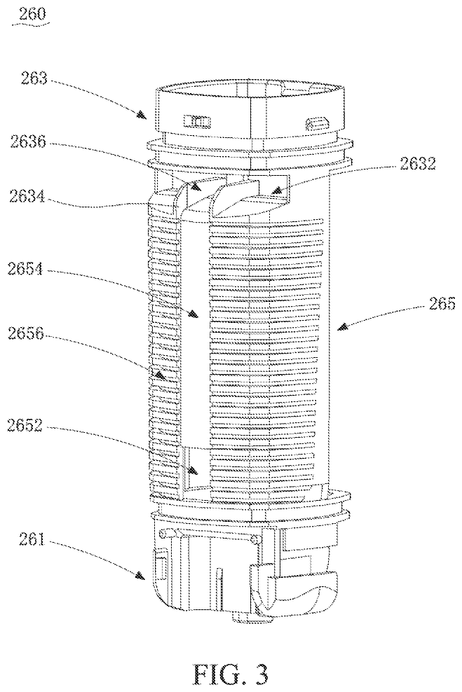

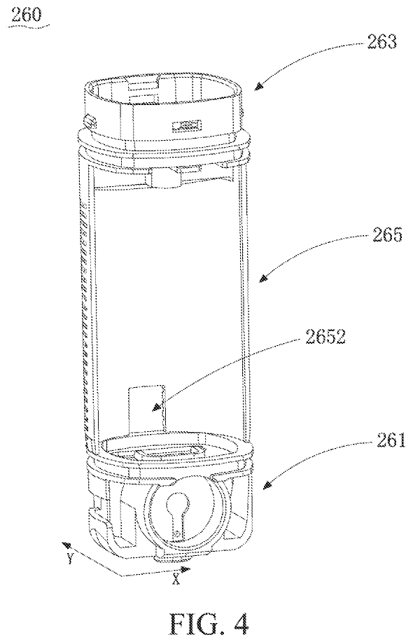

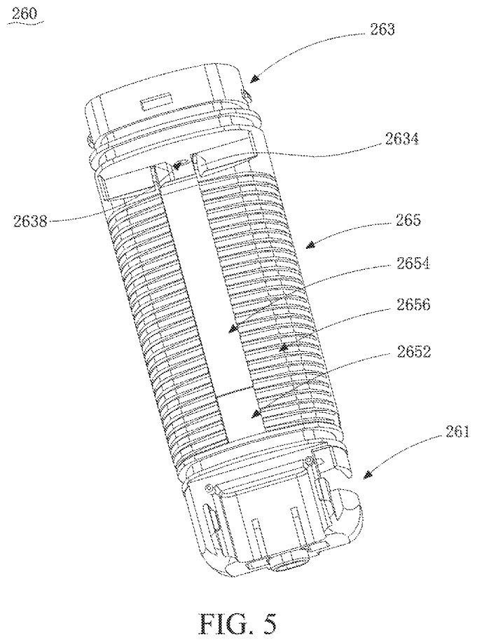

As shown in FIG. 3 to FIG. 5, the installation bracket 260 is shell-shaped and integrally formed. An axial direction of the installation bracket 260 is parallel to an axial direction of the shell 210. The electric core cavity 214 is formed in the center of the installation bracket 260, and the electric control cavity 215 is formed at an end portion of the end of the installation bracket 260 that is close to an air inlet end of the airflow channel. A length direction of the installation bracket 260 is a first direction (that is, a direction X in FIG. 4), and a width direction of the installation bracket 260 is a second direction (that is, a direction Y in FIG. 4).

In the following embodiment, a first axial portion 261 is formed at the end portion of the end of the installation bracket 260 that is away from the vaporization core 140, a second axial portion 263 is formed at the end portion of the end of the installation bracket 260 that is close to the vaporization core 140, and a part of the installation bracket 260 that connects the first axial portion 261 and the second axial portion 263 forms an intermediate connection portion 265.

Specifically, the first axial portion 261 forms inward recessed grooves on two sides in the second direction respectively, and groove walls of the grooves and the cavity wall of the accommodating cavity jointly define to form two electric control cavities 215. The two electric control cavities 215 are spaced apart in the second direction. One electric control cavity 215 has a rectangular cross-section that is perpendicular to the second direction to accommodate the charging plate 250, and the other electric control cavity 215 has a circular cross-section that is perpendicular to the second direction to accommodate the microphone 240. The top wall of the side of the second axial portion 263 that faces away from a first axial end 261 is recessed inwardly to form a groove for accommodating the vaporization core 140.

The intermediate connection portion 265 is located on the side of the installation bracket 260 that is provided with a charging plate 250 in the second direction. The intermediate connection portion 265 is bent and extends around the central axis of the installation bracket 260, and the cross-section of the intermediate connection portion 265 perpendicular to the axial direction is generally in a semicircular arc shape. One end of the intermediate connection portion 265 is connected to the edge of the end surface of the end of the first axial portion 261 that faces the second axial portion 263, and the other end of the intermediate connection portion 265 is connected to the edge of the end surface of the end of the second axial portion 263 that faces the first axial portion 261.

In this way, the intermediate connection portion 265, together with the first axial portion 261, the second axial portion 263, and the shell 210, define to form the electric core cavity 214. The inner side wall of the intermediate connection portion 265 forms the cavity side wall of the end of the electric core cavity 214, and the inner side wall of the shell 210 forms the cavity side wall of the other end of the electric core cavity 214. An end surface of the end of the first axial portion 261 that faces the second axial portion 263 forms the cavity bottom wall of the electric core cavity 214, and an end surface of the end of the second axial portion 263 that faces the first axial end forms the cavity top wall of the electric core cavity 214. When the electric core 230 is accommodated in the electric core cavity 214, the side of the electric core 230 in the radial direction is shielded by the intermediate connection portion 265, and the other side of the electric core 230 in the radial direction is exposed outside the intermediate connection portion 265. End surfaces of two ends of the electric core 230 are respectively shielded by the cavity bottom wall and the cavity top wall of the electric core cavity 214.

It can be understood that the structure of the installation bracket 260 is not limited to this. The installation bracket 260 may be an integrally formed structure, or may be assembled with a plurality of components. The shape of the installation bracket 260 can be designed according to the shapes of the shell 210, the electric core 230, and various electric control components to meet different requirements. In other embodiments, each cavity may not be formed by the installation bracket 260. The arrangement position of the electric control cavity 215 may not be limited to the end portion of the end of the installation bracket 260 that is away from the vaporization core 140 but other positions. A quantity of electric control cavities 215 may not be limited to two, and may be set according to the quantity and shape of the electric control components to meet different requirements.

The first axial portion 261 of the installation bracket 260 that is away from the vaporization core 140 is provided with an air inlet hole 2612, the air inlet hole 2612 is configured to form an air inlet end of the airflow channel, and the bottom wall of the shell 210 is correspondingly provided with a through hole that is in communication with the air inlet hole 2612. Specifically, the air inlet hole 2612 is formed in the center of the first axial portion 261 and is located between the two electric control cavities 215. One end of the air inlet hole 2612 is in communication with the end surface of the end of the first axial portion 261 that is away from the intermediate connection portion 265, and the other end of the air inlet hole 2612 is bent and extends through the two electric control cavities 215 to the end surface of the end of the first axial portion 261 that connects the intermediate connection portion 265. In this way, one end of the air inlet hole 2612 is in communication with the external environment through the through hole on the shell 210, and the other end of the air inlet hole 2612 is in communication with the electric core cavity 214. Air in the external environment can enter the electric core cavity 214 through the air inlet hole 2612.

The side wall of the end of the intermediate connection portion 265 of the installation bracket 260 that is close to the air inlet hole 2612 is provided with a first air outlet hole 2652 used for forming the airflow channel. The first air outlet hole 2652 is in communication with the electric core cavity 214 and the outer side wall of the installation bracket 260, and the first air outlet hole 2652 is located in the center of the installation bracket 260 in the first direction. In this way, the airflow in the electric core cavity 214 may flow out of the electric core cavity 214 together through the first air outlet hole 2652 without flowing to other regions in the electric core cavity 214.

Further, the end surface of the end of the electric core 230 accommodated in the electric core cavity 214 that is close to the air inlet hole 2612 is a non-flat surface, so there is a gap between the electric core 230 and the cavity wall of the electric core cavity 214 (that is, the end surface of the end of the first axial portion 261 that faces the electric core cavity 214) that communicates the air inlet hole 2612 and the first air outlet hole 2652.

In this way, the airflow flowing in from the air inlet hole 2612 can flow out of the electric core cavity 214 from the first air outlet hole 2652 after passing through the gap between the end surface of the end of the electric core 230 and the cavity wall of the electric core cavity 214. Due to the fact that the airflow channel avoids most of the region of the electric core cavity 214, and during the suction, the end of the installation bracket 260 that is away from the vaporization core 140 is at a lower position in the gravitational direction, so that the condensate does not flow to other positions of the electric core 230, so that short circuits do not occur.

Further, the outer side wall of the intermediate connection portion 265 of the installation bracket 260 is provided with a communication groove 2654 used for forming the airflow channel. The communication groove 2654 is located in the center of the installation bracket 260 in the first direction. One end of the communication groove 2654 is in communication with the first air outlet hole 2652, and the other end of the communication groove 2654 extends along the axial direction of the installation bracket 260 to the second axial portion 263 of the installation bracket 260 that is close to the vaporization core 140. In this way, the airflow flowing out of the first air outlet hole 2652 flows through the communication groove 2654 to the vaporization core 140 without diffusing to various regions of an external space of the installation bracket 260.

The side of the second axial portion 263 of the end of the installation bracket 260 that is close to the vaporization core 140 and that is connected to the intermediate connection portion 265 is provided with an airflow guide groove 2632, and the airflow guide groove 2632 is internally provided with two airflow guide plates 2634. The two airflow guide plates 2634 are spaced along the first direction to form an airflow guide channel 2636 that is in communication with the communication groove 2654, and the airflow guide channel 2636 is located downstream of the communication groove 2654 and used to guide the gas in the communication groove 2654 in a direction that is close to the axis of the installation bracket 260.

The second axial portion 263 is provided with a second air outlet hole 2638 used for forming the airflow channel. The second air outlet hole 2638 is located downstream of the airflow guide channel 2636. The central axis of the second air outlet hole 2638 extends along the axial direction of the installation bracket 260. The airflow guide channel 2636 and the vaporization core 140 are in communication through the second air outlet hole 2638, and the second air outlet hole 2638 is used for allowing the gas in the airflow guide channel 2636 to flow out of the installation bracket 260 to enter the vaporization core 140.

In this way, the airflow flowing out of the airflow guide channel 2636 can enter the vaporization core 140 through the second air outlet hole 2638, and then carry the aerosol generated by the aerosol-forming substrate through heating and vaporizing by the vaporization core 140 into an air outlet channel 212.

In some embodiments, in order to prevent the condensate generated by the return airflow when cooled from flowing into the electric core cavity 214 or the electric control cavity 215, a liquid storage groove 2656 is also provided on the outer side wall of the intermediate connection portion 265 of the installation bracket 260. As a preferred embodiment, the outer side wall of the installation bracket 260 is provided with two sets of liquid storage grooves 2656. The two sets of liquid storage grooves 2656 are respectively arranged on two sides of the communication groove 2654 along the first direction. Each set of liquid storage grooves 2656 includes a plurality of liquid storage grooves 2656, and all the liquid storage grooves 2656 in the same set are spaced along the axial direction of the installation bracket 260. Each liquid storage groove 2656 extends along the circumferential direction of the installation bracket 260 and is arc-shaped. It can be understood that the quantity, the shape, and the arrangement position of the liquid storage groove 2656 are not limited to this, and can be set as needed to meet different requirements.

In some embodiments, as shown in FIG. 2, the power supply assembly 200 further includes a liquid absorbing member 270. The liquid absorbing member 270 is embedded in the airflow guide groove 2632 in the second axial portion 263 and faces the airflow guide channel 2636 along the axial direction of the installation bracket 260. In this way, the liquid absorbing member 270 is located between the airflow guide channel 2636 and the second air inlet hole 2612. The condensate generated by the airflow flowing through the second air inlet hole 2612 and the airflow guide channel 2636 can be absorbed by the liquid absorbing member 270, thereby preventing the condensate from adhering to the electric core 230 or other electric control components. It can be understood that there is no limit to the materials used to make the liquid absorbing member 270. Specifically, in an embodiment, the liquid absorbing member 270 is made of a porous material (such as a liquid absorbent cotton), which has a good absorption effect.

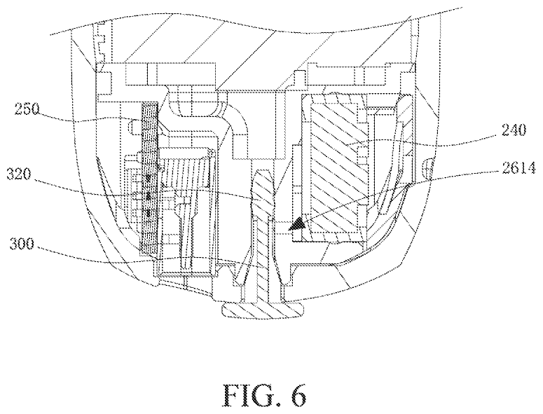

Referring to FIG. 6, in some embodiments, the first axial portion 261 is provided with a start channel 2614. One end of the start channel 2614 is in communication with the inner surface of the air inlet hole 2612, and the other end of the start channel 2614 extends along the radial direction of the shell 210 to the electric control cavity 215 for accommodating the microphone 240, so that the air inlet hole 2612 is in communication with a sensing surface of the microphone 240. The surface of the side of the microphone 240 that faces away from the start channel 2614 is in communication with the external atmosphere.

When the user sucks the electronic vaporization device 100, the airflow is generated in the start channel 2614 that is in communication with the air inlet hole 2612, which makes a pressure difference between the surfaces of two sides of the microphone 240. The microphone 240 then controls the electronic vaporization device 100 to be turned on to generate the aerosol-forming substrate for the user to inhale.

It can be understood that since the microphone 240 is arranged at the first axial portion 261 of the installation bracket 260, the surface of the side of the microphone 240 that faces away from the start channel 2614 can be better in communication with the external atmosphere, so that the microphone 240 is more sensitive to be turned on.

In order to prevent liquid leakage from the electronic vaporization device 100 during transportation, a first seal plug 300 can be inserted into the air inlet hole 2612, and a second seal plug 400 can be inserted into the air outlet end of the air exhaust channel 160, thereby forming a closed environment within the shell 210.

During the research process, the applicant found that when the sensing surface of the microphone 240 is in communication with the closed environment formed within the shell 210, due to the other surface of the microphone 240 that faces away from the sensing surface is in communication with the external atmosphere, a pressure difference occurs on two sides of the microphone 240, causing the electronic vaporization device 100 to be turned on abnormally.

In order to resolve the foregoing problem, the air inlet hole 2612 of this application is provided with a seal surface located downstream of the start channel 2614, and the end of the first seal plug 300 inserted in the air inlet hole 2612 is provided with a seal portion 281 that is engaged in a sealing manner with the seal surface. When the first seal plug 300 is inserted into the air inlet hole 2612, the first seal plug 300 is engaged in a sealing manner with the seal surface of the air inlet hole 2612 through the seal portion 281. The start channel 2614 is located on the side of the first seal plug 300 that is away from the first air outlet hole 2652. Therefore, the start channel 2614 is in communication with the external atmosphere through the gap between the first seal plug 300 and the air inlet hole 2612, so that the microphone 240 is located outside the closed environment formed in the shell 210 and is in communication with the external atmosphere. The pressures of the sensing surface of the microphone 240 and the other surface facing away from the sensing surface are always consistent, so as to avoid abnormal startup of the electronic vaporization device 100 due to pressure differences sensed by the microphone 240 because the transportation or the external environmental changes. Specifically, in an embodiment, the inner surface of the end of the air inlet hole 2612 that is close to the electric core cavity 214 forms the seal surface, and an outer diameter of the seal portion 281 is greater than an inner diameter of the air inlet hole 2612 that forms the seal surface, thereby being engaged in a sealing manner with the seal surface of the air inlet hole 2612.

The foregoing electronic vaporization device 100 divides the internal space of the shell 210 into the electric core cavity 214 and at least one electric control cavity 215 that are independently arranged. Since the airflow channel in the shell 210 is arranged independently of the electric control cavity 215 and avoids most regions of the electric core cavity 214, the condensate generated by the return airflow in the airflow channel does not adhere to the electric control components located in the electric control cavity 215, significantly reducing the risk of short circuits. In addition, after the first seal plug 300 and the second seal plug 400 are inserted, the pressure of the surfaces of two sides of the microphone 240 remains consistent, so that abnormal startup of the electronic vaporization device 100 can be avoided when the transportation or the environment changes.

The technical features in the foregoing embodiments may be randomly combined. For concise description, not all possible combinations of the technical features in the embodiment are described. However, provided that combinations of the technical features do not conflict with each other, the combinations of the technical features are considered as falling within the scope recorded in this specification.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

What is claimed is:

1. A power supply assembly, comprising:
an electric core cavity and an electric control cavity that are independent of each other, the electric core cavity and electric control cavity being internally provided; and
an airflow channel that is independent of the electric control cavity, the airflow channel being internally provided and extending from one end of the power supply assembly through the electric core cavity to an other end of the power supply assembly.

2. The power supply assembly of claim 1, further comprising:
a shell provided with an accommodating cavity; and
an installation bracket accommodated in the accommodating cavity, the installation bracket separating the accommodating cavity to form the electric core cavity and the electric control cavity.

3. The power supply assembly of claim 2, wherein the electric control cavity is formed at an end portion of one end of the installation bracket that is close to an air inlet end of the airflow channel.

4. The power supply assembly of claim 2, wherein an end portion of one end of the installation bracket is provided with an air inlet hole for forming the airflow channel, one end of the air inlet hole being in communication with an external environment, and an other end of the air inlet hole being in communication with the electric core cavity.

5. The power supply assembly of claim 4, wherein a side wall of one end of the installation bracket that is close to the air inlet hole is provided with a first air outlet hole for forming the airflow channel, and
wherein the electric core cavity and an outer side wall of the installation bracket are in communication through the first air outlet hole.

6. The power supply assembly of claim 5, further comprising:
an electric core accommodated in the electric core cavity,
wherein a gap communicating the air inlet hole with the first air outlet hole exists between an end surface of one end of the electric core close to the air inlet hole and a cavity wall of the electric core cavity.

7. The power supply assembly of claim 5, wherein the outer side wall of the installation bracket is provided with a communication groove for forming the airflow channel, one end of the communication groove being in communication with the first air outlet hole, and an other end of the communication groove extending to an end portion of one end of the installation bracket that is away from the air inlet hole.

8. The power supply assembly of claim 7, wherein the outer side wall of the installation bracket is provided with a liquid storage groove, the liquid storage groove being in communication with the communication groove.

9. The power supply assembly of claim 7, wherein the end portion of the end of the installation bracket that is away from the air inlet hole is provided with an airflow guide channel for forming the airflow channel, and
wherein the airflow guide channel is located downstream of the communication groove and is configured to guide a gas in the communication groove toward an axis of the installation bracket.

10. The power supply assembly of claim 9, wherein the end portion of the end of the installation bracket that is away from the air inlet hole is provided with a second air outlet hole for forming the airflow channel, and
wherein the second air outlet hole is located downstream of the airflow guide channel for gas in the airflow guide channel to flow out of the installation bracket.

11. The power supply assembly of claim 10, further comprising:
a liquid absorbing member embedded in the end portion of the end of the installation bracket that is away from the air inlet hole, the liquid absorbing member facing the airflow guide channel along an axial direction of the installation bracket.

12. The power supply assembly of claim 1, wherein the power supply assembly is provided with an air inlet hole that forms the airflow channel, one end of the air inlet hole being in communication with an external environment, an other end of the air inlet hole being in communication with the electric core cavity, and the air inlet hole being provided with a seal surface configured to be engaged in a sealing manner with a seal plug that seals the air inlet hole,
wherein the power supply assembly further comprises a microphone accommodated in the electric control cavity,
wherein an inner surface of the air inlet hole is provided with a start channel that is in communication with the electric control cavity for accommodating the microphone, and
wherein the start channel is located upstream of the seal surface.

13. An electronic vaporization device, comprising:
the power supply assembly of claim 1; and
a vaporization assembly,
wherein the vaporization assembly is engaged with one end of the power supply assembly and is in communication with the airflow channel.
